(19) United States
(12) Patent Application Publication
(10) Pub. No.: US 2021/0394808 A1
(43) Pub. Date: Dec. 23, 2021

(54) The Grocery Buddy

(71) Applicant: Kevin Lee Trask, Yuba City, CA (US)

(72) Inventor: Kevin Lee Trask, Yuba City, CA (US)

(21) Appl. No.: 16/905,820

(22) Filed: Jun. 18, 2020

(51) Int. Cl. B62B 5/06

(52) U.S. Cl. CPC B62B 5/069

(57) ABSTRACT

The Grocery Buddy is designed to keep your hands from touching bacteria and viruses that are often found on Grocery cart handles. The Buddy keeps things sanitize so you don't need to wear gloves.

### BACKGROUND OF THE INVENTION

The Grocery Buddy is designed to keep your hands from touching bacteria and viruses that are often found on Grocery cart handles. The Buddy keeps things sanitize so you don't need to wear gloves.

### BRIEF SUMMARY OF THE INVENTION

The advantage of using the grocery buddy is that your hands stay clean and clear of the viruses and bacteria that live on grocery carts. The Grocery Buddy is designed to keep your hands from touching bacteria and viruses that are often found on Grocery cart handles. The Buddy keeps things sanitize so you don't need to wear gloves.

### BRIEF DESCRIPTION OF THE VIEW OF THE DRAWING

FIG. 1 is the front view of the buddy opened up with the clips off the buddy showing the inside of the invention.

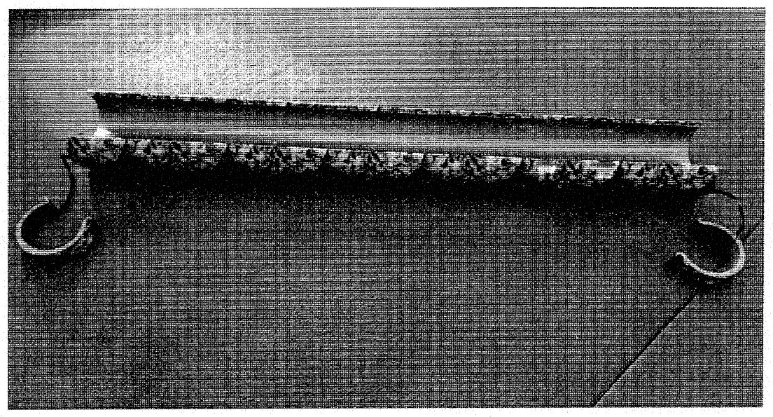

### DETAILED DESCRIPTION OF THE INVENTION

The Grocery Buddy is a custom printed pipe. The pipe is cut down the middle length wise to open up around the handle. Each cover is secured with adjustable fasteners to secure it. When done using the Buddy, sanitize it inside and outside with the sanitizer which is included in your package. Then it will be ready for the next use. The Sanitizer bottle comes in a variety of scents. You can personalize your Buddy by choosing from the many variations of colors and designs to pick from.

I. The Grocery Buddy is a custom printed pipe and cut length wise

II. Each cover is secured with a adjustable fasteners to secure it.

III. The Buddy Sanitizer bottle comes in a variety of scents.
